(19) United States
(12) Patent Application Publication
(10) Pub. No.: US 2016/0171958 A1
(43) Pub. Date: Jun. 16, 2016

(54) SLANTED BORE MOUTHPIECE

(71) Applicant: Philip Lee Rovner, Timonium, MD (US)

(72) Inventor: Philip Lee Rovner, Timonium, MD (US)

(21) Appl. No.: 14/567,281

(22) Filed: Dec. 11, 2014

(51) Int. Cl. G10D 7/06

(52) U.S. Cl. CPC G10D 7/06

(57) ABSTRACT

A slanted bore mouthpiece has a central axis running through the mouthpiece, a tone chamber within the mouthpiece, a generally rectangular window exposing the tone chamber and extending from a front end of the window adjacent a first end of the mouthpiece along the mouthpiece to a rear end of the window at a table disposed on an outer surface of the mouthpiece and configured to engage a reed and a mouthpiece bore passing through the mouthpiece from a second end of the mouthpiece opposite the first end to the tone chamber at the rear end of the window. The mouthpiece bore extends along a mouthpiece bore axis, and the central axis and the mouthpiece bore axis are divergent axes.

### FIELD OF THE INVENTION

The present invention relates to woodwind instruments and in particular to mouthpieces for woodwind instruments.

### BACKGROUND OF THE INVENTION

Woodwind musical instruments, e.g., saxophones and clarinets, and other devices such as bird calls, utilize the vibration of a reed in response to a flow of air to generate a tone. These reeds include natural cane reeds and synthetic reeds. Tone generation in general depends on proper reed vibration. The reed is typically placed in contact with a mouthpiece to cover an opening or window. The reed is held in place by an adjustable clamp or ligature that surrounds the mouthpiece and the reed. Variations in the mouthpiece and ligature affect the vibration of the reed and, therefore, the performance or tone of the device or instrument.

The essential function of the mouthpiece of a woodwind instrument is to provide support for the reed over an aperture that allows the reed to vibrate and to direct the energy from the reed vibration through the aperture and into the bore of the instrument. The function and performance of a mouthpiece is influenced by the arrangement and geometry of the facing around the aperture as well as tone chamber below the reed which defines the route from the aperture to the bore. The facing is conventionally a flat surface on the mouthpiece surrounding the aperture, and the reed is placed in contact with this flat surface, covering the aperture. The facing includes the aperture, called a window, and the window is surrounded by a table on one end, two side rails extending from the table and a tip rail opposite the table. The reed functions as a reed valve during vibration, opening and closing the window.

Unlike pianos, guitars, and similar musical instruments where the pitch of each note is precisely fixed, woodwind instruments require greater playing proficiency to achieve an acceptable level of pitch accuracy. Often, even after many years of study, many players are not able to satisfactorily produce good intonation absent significant effort. This problem is especially severe in hard rubber type mouthpieces. Hard rubber mouthpieces have a standardized external configuration that, in particular, is favored in the school-band venue. A major cause of the problem is the configuration of the window into the tone chamber that exists at the rear of the window in the standard configuration. The standard configuration produces, during operation, a shock front that tends to partially acoustically decouple the reed from the air column in the instrument. This permits the reed's own resonance to influence the air column resonance with regard to pitch. Therefore, if the reed's resonances are not directly or harmonically related to that of the air column, on a specific note, the air column frequency is pulled from the ideally produced frequency, causing the note to be out of tune. An accomplished player can correct this by way of nuanced changes in the position and pressure of the lip on the reed. However, if the effort to accomplish this can be reduced, the player can achieve the desired tone with less effort.

A conventional standard hard rubber woodwind mouthpiece has a geometry that offsets the bore from the facing at the rear of the window into the tone chamber, i.e., the transition from the table around the rear of the window and into the tone chamber. This facing creates an abutment at the rear of the window, resulting in an abrupt change in cross-sectional area of the internal cavity of the mouthpiece from the tone chamber to the bore. This abrupt change in cross-sectional area creates an impedance discontinuity. Anytime a discontinuity exists in an acoustic environment a shock front is created that causes reflections in two directions. This effectively creates a degree of isolation of one section of the vibrating air column from the opposite section. In a woodwind instrument this causes the coupling of the air column to the reed to be reduced, allowing the reed's resonances to influence the pitch. Therefore, an internal mouthpiece geometry is desired that eliminates this abrupt change in cross-sectional geometry.

### SUMMARY OF THE INVENTION

The present invention is directed to woodwind mouthpieces that mitigate intonation problems by reconfiguring the internal cavities of single reed woodwind instrument mouthpieces, for example, the standard hard rubber mouthpieces to provide a noticeable improvement in intonation, tonality and ease of performance. By reducing the abrupt change in cross-sectional area of the mouthpiece at the rear of the window as the table transitions into the tone chamber, the coupling of the reed-to-air column is intensified, and a lessening of pitch deviation occurs. In one embodiment, the bore of the mouthpiece is slanted or offset from the central axis of the mouthpiece. This can be achieved through a cylindrical bore that is symmetric about its own axis but is not aligned with the central axis of the mouthpiece, i.e., the cylindrical bore is slanted or tilted as it passes through the mouthpiece. Alternatively, a cylindrical arrangement of the bore is used in which the bore radius increases as it passes through the mouthpiece, either evenly around the bore axis or a-symmetrically around the bore axis. By offsetting the bore from the central axis of the mouthpiece or flaring the bore outward as it passes into the mouthpiece, the bore intersects the facing surface at the rear of the window in an even transition, eliminating the abrupt surface and effecting a channeling of the window as it junctions with the bore.

A geometry is created that greatly reduces the abruptness of change of cross-sectional area to that of a transitional geometry, softening the shock and reducing reflection. This intensifies the coupling of the reed to the air column and allows the greater resonant energy of the air column to dominate the resonant frequency, improving the accuracy and consistency of pitch. In one embodiment, the width of the rear of the window is increased from that of the conventional woodwind mouthpiece to optimize the transitional geometry.

In accordance with one exemplary embodiment, the present invention is directed to a slanted bore mouthpiece have a central axis running through the mouthpiece, a tone chamber within the mouthpiece, a generally rectangular window exposing the tone chamber and extending from a front end of the window adjacent a first end of the mouthpiece along the mouthpiece to a rear end of the window at a table disposed on an outer surface of the mouthpiece and configured to engage a reed and a mouthpiece bore passing through the mouthpiece from a second end of the mouthpiece opposite the first end to the tone chamber at the rear end of the window. The he mouthpiece bore extends along a mouthpiece bore axis, and the central axis and the mouthpiece bore axis are divergent axes. In one embodiment, the mouthpiece bore has a circular cross section, and this circular cross section is concentric with the central axis at the second end of the mouthpiece. In one embodiment, the mouthpiece bore has an outer wall, and the outer wall intersects the table at the rear end of the window.

In another exemplary embodiment, the present invention is directed to a slanted bore mouthpiece having a central axis running through the mouthpiece, a tone chamber within the mouthpiece, a generally rectangular window exposing the tone chamber and extending from a front end of the window adjacent a first end of the mouthpiece along the mouthpiece to a rear end of the window at a table disposed on an outer surface of the mouthpiece and configured to engage a reed and a mouthpiece bore passing through the mouthpiece from a second end of the mouthpiece opposite the first end to the tone chamber at the rear end of the window. The mouthpiece bore has a circular cross section adjacent the second end of the mouthpiece and an elongated cross section adjacent the tone chamber. In one embodiment, the circular cross section is concentric with the central axis at the second end, and the elongated cross section is an elliptical cross section. The elliptical cross section has a first focal point, and the central axis passes through the first focal point. In addition, the elliptical cross section has a second focal point disposed between the first focal point and the table. In one embodiment, the mouthpiece bore has an outer wall, and the outer wall intersects the table at the rear end of the window.

In another exemplary embodiment, the present invention is directed to a slanted bore mouthpiece having a central axis running through the mouthpiece, a tone chamber within the mouthpiece, a generally rectangular window exposing the tone chamber and extending from a front end of the window adjacent a first end of the mouthpiece along the mouthpiece to a rear end of the window at a table disposed on an outer surface of the mouthpiece and configured to engage a reed and a mouthpiece bore passing through the mouthpiece from a second end of the mouthpiece opposite the first end to the tone chamber at the rear end of the window. The mouthpiece bore has an outer wall extending along its length, and the outer wall intersects the table at the rear end of the window.

### BRIEF DESCRIPTION OF THE DRAWINGS

FIG. 1 is a view of an embodiment of the slanted bore mouthpiece in accordance with the present invention;

FIG. 2 is a view through line 2-2 of FIG. 1;

FIG. 3 is an end view of an embodiment of the slanted bore mouthpiece as indicated by line 3-3 of FIG. 2;

FIG. 4 is a cross-sectional view of an embodiment of the slanted bore mouthpiece as indicated by line 4-4 of FIG. 2;

FIG. 5 is a view of another embodiment of the slanted bore mouthpiece through line 2-2 of FIG. 1;

FIG. 6 is an end view of an embodiment of the slanted bore mouthpiece as indicated by line 6-6 of FIG. 5; and

FIG. 7 is a cross-sectional view of an embodiment of the slanted bore mouthpiece as indicated by line 7-7 of FIG. 5.

### DETAILED DESCRIPTION

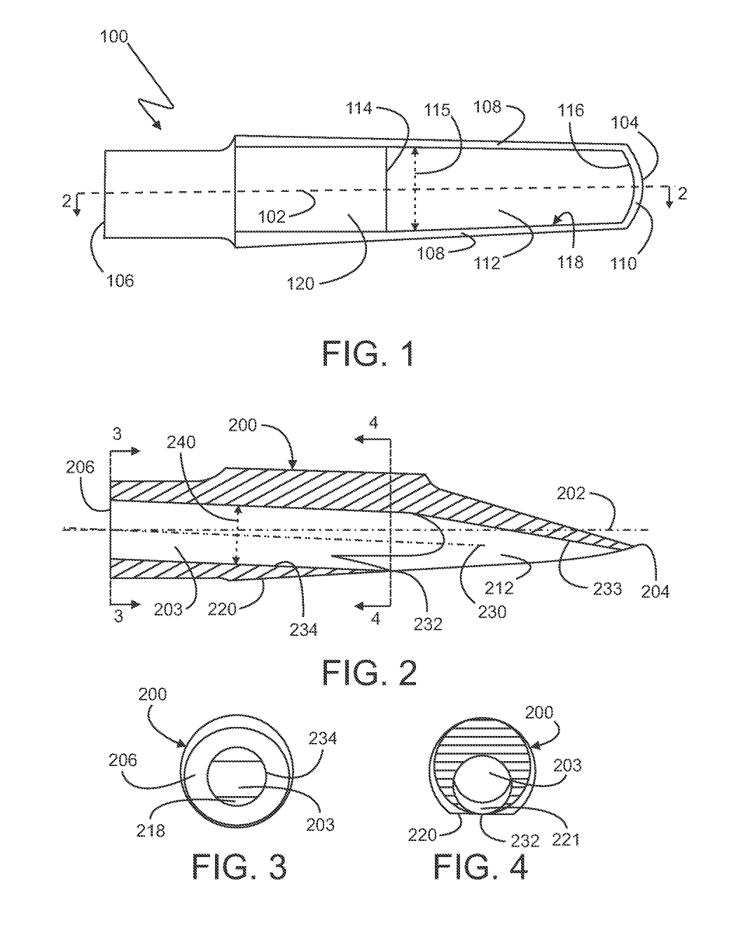

Referring initially to FIG. 1, an exemplary embodiment of a slanted bore mouthpiece 100 for a single reed woodwind instrument in accordance with the present invention is illustrated. In general, the mouthpiece is arranged to support a reed that is secured to the mouthpiece with a ligature. Suitable arrangements of reeds and ligatures are known and available in the art. The slanted bore mouthpiece can be any suitable type of single reed mouthpiece including mouthpieces for clarinets and saxophones. In general, the mouthpiece has a typically elongated or barrel shape that extends along a central axis 102 from a first end 104 to a second end 106. The slanted bore mouthpiece tapers toward the first end, which is the end inserted into the mouth of the player of the woodwind instrument. The second end is typically cylindrical and is shaped to fit on the neck of the woodwind instrument or into the barrel of a clarinet.

The slanted bore mouthpiece includes an internal tone chamber 112. Typically, the tone chamber has a rectangular cross section when viewed perpendicular to the central axis of the mouthpiece. The slanted bore mouthpiece includes an elongated window 118 that extends from a front end 116 adjacent the first end 104 of the slanted bore mouthpiece along the slanted bore mouthpiece to a rear end 114. The window exposes the tone chamber 112. The window has a generally rectangular shape and is framed along the sides by two side rails 108 and a tip rail 110 at its front end. The rear end of the window is located at a table 120 disposed on an outer surface of the mouthpiece. While the outer surface of the mouthpiece is generally rounded, the table is flat and is configured to engage a reed (not shown). In particular, the table engages the heel end of the reed, and the ligature is positioned around the reed and mouthpiece at the table to secure the reed to the mouthpiece. The reed extends over the window to the tip rail, having sufficient width to cover the side rails. In one embodiment, the tip rail is bowed or arched to match the curvature of the end of the reed. In one embodiment, the table has an overall length of from about 15 mm to about 20 mm, preferably about 17 mm.

The side rails run along opposite sides of the window. Each side rail frames one side of the window. The side rails extend from the table. In one embodiment, the side rails extend perpendicularly from the table. Alternatively, the side rails flare outwards or inwards as they extend from the table. The side rails are parallel in that the side rails do not cross or intersect in the region of the window. Each side rail includes a side rail top surface running along the length of the side rail. The top surface of each side rail contacts a portion of the reed. In one embodiment, each side rail has a length of about 50 mm. In one embodiment, the width of each side rail top surface varies from about 3 mm at the table to about 1 mm at the other end of the side rail. In one embodiment, each side rail top surface is coplanar with the table top. Alternatively, each side rail top surface is coplanar with the table top at the point of intersection of the side rail with the table top and subsequently curves away from the plane of the table top. This curvature provides for separation between the reed and the side rail top surfaces at an end of the reed opposite the heel end. This separation occurs, for example, when the reed is attached to the mouthpiece and is not vibrating. Vibration of the reed causes the reed to come into contact with the side rail top surfaces along the entire length of the top rails. The reed in combination with the window acts as a valve for the tone chamber.

The tip rail 110 extends between the side rails at an end of the window opposite the table. In one embodiment, the tip rail extends along a generally straight line between the side rails. Preferably, the tip rail follows an outward arc between the side rails. The tip rail is in contact with the reed when the reed vibrates to close the window in the tone chamber. In one embodiment, the tip rail spans a distance between the side rails of about 15 mm. The shape of the tip rail can be the same as the shape of the tip of the reed or can be an arc having a different curvature than the tip of the reed. The tip rail top surface is the portion of the tip rail that comes onto contact with the reed. In one embodiment, the tip rail top surface has a width of up to about 1 mm. In one embodiment, the tip rail top surface is coplanar with the side rail top surfaces at the points of intersection between the side rails and the tip rail.

In one embodiment, the width 115 of the window decreases from the front end to the rear end. This can also correspond to a narrowing of the distance between the side walls of the tone chamber. In order to prevent a constriction in the vibrating air column in the tone chamber, preferably the width 115 of the window, and therefore, the distance between the side walls in the tone chamber, is constant along the length of the window. Therefore, the width of the window at the front end is the same as the width of the window at the rear end or table. Alternatively, the width may be narrowed slightly or may be increased from the front end to the rear end. The side of the mouthpiece containing the window is considered the bottom side, because that side typically faces down or is on the bottom of the mouthpiece when the mouthpiece is attached to a musical instrument, i.e., a clarinet or saxophone.

Referring to FIGS. 2-4, in accordance with one exemplary embodiment of the slanted bore mouthpiece 200, a mouthpiece bore 203 passes through the mouthpiece from the second end 206 of the mouthpiece opposite the first end 204 to the tone chamber 212. The mouthpiece bore intersects the tone chamber at the rear end of the window 218. The mouthpiece bore extends along a mouthpiece bore axis 230. The central axis 202 and the mouthpiece bore axis 230 are divergent axes. These axes are not parallel to each other and the mouthpiece bore axis is not co-axial with the central axis along the entire length of the mouthpiece bore. Therefore, the mouthpiece bore slopes or is slanted with respect to the central axis as is passes through the mouthpiece. The slanted mouthpiece bore facilitates a smoother transition between the tone chamber and the mouthpiece bore, both at the bottom of the tone chamber 233 and at the point of intersection 232 between the table 220 and the outer wall 234 of the mouthpiece bore. In one embodiment, the outer wall of the mouthpiece bore and the table meet at a point. Alternatively, this intersection 232 has a small thickness, for example, from about 1 mm to about 3 mm. This small thickness can be generally flat and perpendicular to the mouthpiece bore axis. Alternatively, the transitional thickness at the intersection is rounded or curved.

The mouthpiece bore can have any suitable cross sectional shape including rectangular, square, circular, oblong or elliptical. In this embodiment, the mouthpiece bore has a circular shape along an entire length of the mouthpiece bore. Preferably, the width 240 of the mouthpiece bore, or diameter for a circular cross section cylindrical mouthpiece bore, is constant along the entire length of the mouthpiece bore. At the second end 206 of the mouthpiece, the circular cross section is concentric with the central axis 202 of the mouthpiece. The mouthpiece bore axis 230 then diverges from the central axis 202 along the length of the mouthpiece bore. This defines a smoothly sloped inner surface 221 of the mouthpiece bore, which in combination with the pointed transition between the mouthpiece bore and the table, eliminates the tonality problems caused by abrupt changes in the internal mouthpiece geometry.

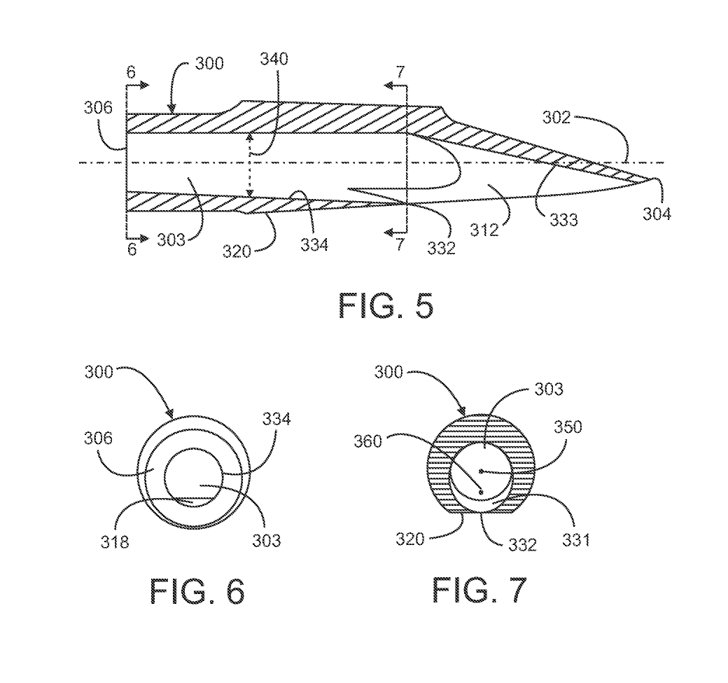

Referring to FIGS. 5-7, in accordance with another exemplary embodiment of the slanted bore mouthpiece 300, a mouthpiece bore 303 passes through the mouthpiece from the second end 306 of the mouthpiece opposite the first end 304 to the tone chamber 312. The mouthpiece bore intersects the tone chamber at the rear end of the window 318. The mouthpiece bore extends through the mouthpiece generally along the direction of the central axis 302 of the mouthpiece. The mouthpiece bore can have any suitable cross sectional shape including rectangular, square, circular, oblong or elliptical. In this embodiment, the mouthpiece bore has a circular cross section adjacent the second end 306 of the mouthpiece and an oblong or elongated cross section adjacent the tone chamber 312. Therefore, the width 340 of the mouthpiece bore, or diameter for a circular cross section cylindrical mouthpiece bore, varies along the length of the mouthpiece bore. This variation can be smooth and continuous along the length of the mouthpiece bore. Alternatively, the width of the mouthpiece bore can be constant along a portion of the mouthpiece bore length and only elongate or curve outward for a portion of the length adjacent the tone chamber. In general, the mouthpiece bore has an outer wall 334 extending along its length, and the outer wall intersects the table 320 at the rear end of the window 312.

In addition, the cross sectional shape of the mouthpiece bore can vary continuously from circular to elongated or elliptical; however, the symmetry of the mouthpiece bore at any given point along the length of the mouthpiece bore does not have to stay centered on the central axis. In one embodiment, the circular cross section is concentric with the central axis 302 at the second end 306 of the mouthpiece. At the rear end of the window, the elongated cross section comprises an elliptical cross section having a first focal point 350 through which the central axis passes at the point of transition between the mouthpiece bore and the tone chamber. Therefore, the mouthpiece bore extends downward or outward toward the table as it passes along the mouthpiece, and the second focal point 360 of the elliptical end of the mouthpiece bore is disposed between the first focal point 350 and the table 320. This geometry also provides for the outer wall 334 of the mouthpiece bore 303 intersecting the table 320 at the rear end of the window 318.

Again, the geometry of the mouthpiece bore effectively slopes or is slanted as is passes through the mouthpiece. The slanted mouthpiece bore facilitates a smoother transition between the tone chamber and the mouthpiece bore, both at the bottom of the tone chamber 333 and at the point of intersection 332 between the table 320 and the outer wall 334 of the mouthpiece bore. In one embodiment, the outer wall of the mouthpiece bore and the table meet at a point. Alternatively, the intersection 332 has a small thickness, for example, from about 1 mm to about 3 mm. This small thickness can be generally flat and perpendicular to the mouthpiece bore axis. Alternatively, the transitional thickness at the intersection is rounded or curved.

At the second end 306 of the mouthpiece, the circular cross section of the mouthpiece bore is concentric with the central axis 302 of the mouthpiece. The mouthpiece bore then expands or diverges from the central axis 302 along the length of the mouthpiece bore. This defines a smoothly sloped inner surface 321 of the mouthpiece bore, which in combination with the pointed transition between the mouthpiece bore and the table, eliminates the tonality problems caused by abrupt changes in the internal mouthpiece geometry.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A slanted bore mouthpiece comprising:
a central axis running through the mouthpiece;
a tone chamber within the mouthpiece;
a generally rectangular window exposing the tone chamber and extending from a front end of the window adjacent a first end of the mouthpiece along the mouthpiece to a rear end of the window at a table disposed on an outer surface of the mouthpiece and configured to engage a reed; and
a mouthpiece bore passing through the mouthpiece from a second end of the mouthpiece opposite the first end to the tone chamber at the rear end of the window, the mouthpiece bore extending along a mouthpiece bore axis, the central axis and the mouthpiece bore axis comprising divergent axes.

2. The slanted bore mouthpiece of claim 1, wherein the mouthpiece bore comprises a circular cross section.

3. The slanted bore mouthpiece of claim 2, wherein the circular cross section is concentric with the central axis at the second end of the mouthpiece.

4. The slanted bore mouthpiece of claim 1, wherein the mouthpiece bore comprises an outer wall and the outer wall intersects the table at the rear end of the window.

5. A slanted bore mouthpiece comprising:
a central axis running through the mouthpiece;
a tone chamber within the mouthpiece;
a generally rectangular window exposing the tone chamber and extending from a front end of the window adjacent a first end of the mouthpiece along the mouthpiece to a rear end of the window at a table disposed on an outer surface of the mouthpiece and configured to engage a reed; and
a mouthpiece bore passing through the mouthpiece from a second end of the mouthpiece opposite the first end to the tone chamber at the rear end of the window, the mouthpiece bore comprising a circular cross section adjacent the second end of the mouthpiece and an elongated cross section adjacent the tone chamber.

6. The slanted bore mouthpiece of claim 5, wherein the circular cross section is concentric with the central axis at the second end.

7. The slanted bore mouthpiece of claim 6, wherein the elongated cross section comprises an elliptical cross section, the elliptical cross section comprising a first focal point, the central axis passing through the first focal point.

8. The slanted bore mouthpiece of claim 7, wherein the elliptical cross section comprises a second focal point, the second focal point disposed between the first focal point and the table.

9. The slanted bore mouthpiece of claim 5, wherein the mouthpiece bore comprises an outer wall, the outer wall intersecting the table at the rear end of the window.

10. A slanted bore mouthpiece comprising:
a central axis running through the mouthpiece;
a tone chamber within the mouthpiece;
a generally rectangular window exposing the tone chamber and extending from a front end of the window adjacent a first end of the mouthpiece along the mouthpiece to a rear end of the window at a table disposed on an outer surface of the mouthpiece and configured to engage a reed; and
a mouthpiece bore passing through the mouthpiece from a second end of the mouthpiece opposite the first end to the tone chamber at the rear end of the window, the mouthpiece bore comprising an outer wall extending along its length, the outer wall intersecting the table at the rear end of the window.
